(19) United States
(12) Patent Application Publication
(10) Pub. No.: US 2016/0009438 A1
(43) Pub. Date: Jan. 14, 2016

(54) LINERLESS LABEL DEVICE AND METHOD

(71) Applicants: KING ABDULLIAH UNIVERSITY OF SCIENCE AND TECHNOLOGY, Thuwal (SA); GOLDEN LINE, Jeddah (SA)

(72) Inventor: Abdulkarim BINLADEN, Jeddah (SA)

(73) Assignee: GOLDEN LINE, Jeddah (SA)

(21) Appl. No.: 14/773,039

(22) PCT Filed: Mar. 3, 2014
(86) PCT No.: PCT/IB2014/000841

§ 371 Date: Sep. 4, 2015

Related U.S. Application Data
(60) Provisional application No. 61/772,023, filed on Mar. 4, 2013.

(51) Int. Cl. B65C 9/18

(52) U.S. Cl. CPC B65C 9/1803; B65C 9/1807; B65C 2009/0071

(57) ABSTRACT

This apparatus and method for applying a linerless label to an end user product includes a device with a printer for printing on a face surface of a linerless label, and a release coat applicator for applying a release coat to the face surface of the label; another device including an unwinder unit (103) to unwind a roll of printed linerless label; a belt (108); a glue applicator (102) for applying glue to the belt; a nip roller (106) for contacting and applying pressure to the face surface of the linerless label such that the glue on the belt transfers to the back surface of the linerless label; at least one slitting knife 105) positioned downstream the belt and a rewinder unit (104) positioned downstream the slitting knife; and a third device which die cuts and applies the linerless label to an end user object.

### PRIORITY CLAIM

This application claims priority to U.S. Provisional Application No. 61/772,023, filed on Mar. 4, 2013, which is incorporated by reference in its entirety.

### TECHNICAL FIELD

This invention relates to a linerless label application apparatus and method.

### BACKGROUND OF THE INVENTION

An apparatus and method for creating and applying a linerless label to an end user product can provide a more efficient way to apply labels to end-user products.

### SUMMARY

A linerless label preparation device and application device can provide improved application of linerless labels to end user products when the label is individually slit, then die cut, and carried to an applicator unit on a belt instead of using a temporary liner.

In one aspect, a first machine can include a printer, a label, and a release coat applicator. A second machine can include a glue applicator, an unwinder unit, a rewinder unit, at least one slitting knife, a nip roller, a chill roller, and a belt. The unwinder unit and rewinder unit can be used to move the printed label past the belt so that glue can be applied to the printed label. The glue can be applied prior to the slitting of the label into the desired width, and can be applied prior to die-cutting the label to its final dimensions. In another aspect, the release coat and the glue for the label are applied with one machine.

In another aspect, the glue can be applied with a glue application machine. The printed label can be positioned on the unwinder unit, glue can be applied to the belt with the glue applicator, and then the unwinder unit can unwind the label and positions the back of the label on top of the belt. The glue applicator can include a hot melt tank and a slot die for applying the glue to the belt. The nip roller can apply a pressure to the printed face surface of the label which rests on top of the belt, to cause the glue to transfer from the belt to the backside of the face material, or label. In one embodiment, the chill roller and belt can form an integrated unit, such that the belt wraps around the chill roller. In a further embodiment, the belt and chill roller can be in a non-integrated configuration. Once the glue is transferred to the printed material, the slitting knives can slit the label into width sizes desired by the end user. Then the label can be rewound into a roll with the rewinder unit. The label can then be taken to the site of the module, or a second applicator, to be applied to the end user product.

In another aspect, the machine, or module, located at the end user's location can include an unwinder unit, a die cutting station, a belt, and a nip roller.

In another aspect, the glue application and release coat application can be performed at the printer location.

In another aspect, the glue application and release coat application can be performed at the customer location.

In another aspect, a single machine can perform the steps of die cutting a label and placing it on an end user product. In one embodiment, a roll of labels that has been printed can be inserted onto an unwinder unit of the single machine. The label is pulled through the machine with two motors. In one embodiment, the label passes through an anvil cylinder and magnetic cylinder for die cutting. In another embodiment, the label can be passed through a nip roller prior to the die cutting. A belt with a non-stick surface or coating rotates around the anvil cylinder, and the labels are transported on the belt until they reach the end user products and are applied to the end user products. In another embodiment, the roll of labels can be printed and have a release coat and glue applied to it prior to the roll being placed on the unwinder unit.

In another aspect, the module can be attached to an existing applicator device. The label can be positioned on the unwinder, where it is unwound and positioned on the belt, with a nip roller applying pressure against the label and belt. The belt can carry the label through the die cutter apparatus which cuts the label into the end user's desired shape. The belt can then continue to carry the label all the way through the existing applicator unit until it is applied to the end user product. In one embodiment, the die cutter can be cylindrical. In another embodiment, the die cutter can be a laser die cutter. In a further embodiment, the die cutter can be a flat-bed die cutter. In a still further aspect, the excess, or waste label, that is not applied to the end user product can be taken to a rewinding unit of the applicator.

Other aspects, embodiments, and features will be apparent from the following description, the drawings, and the claims.

### DETAILED DESCRIPTION OF THE DRAWINGS

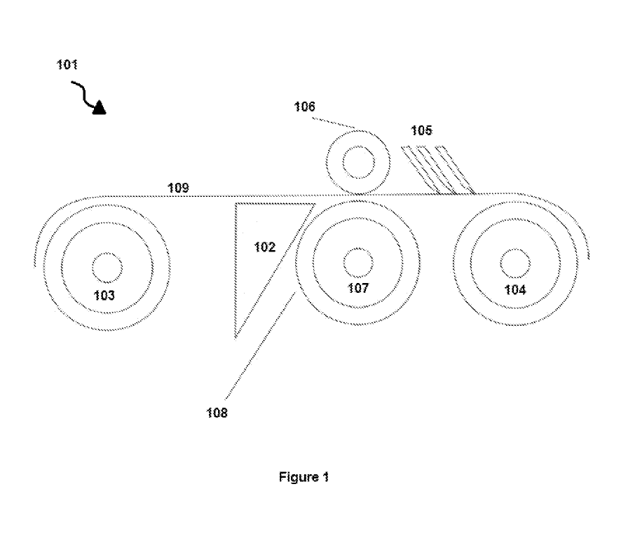

FIG. 1 is an illustration of the device that applies glue to a linerless label.

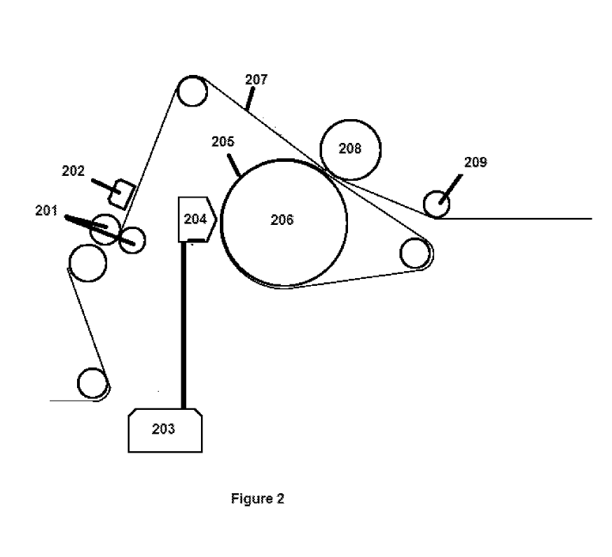

FIG. 2 is an illustration of an alternative embodiment of the device that applies glue to a linerless label.

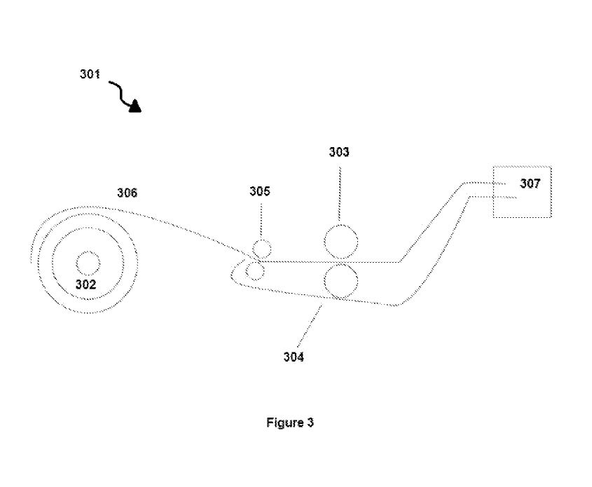

FIG. 3 is an illustration of a module that attached to a pre-existing label applicator that allows a linerless label to be applied to an end user object.

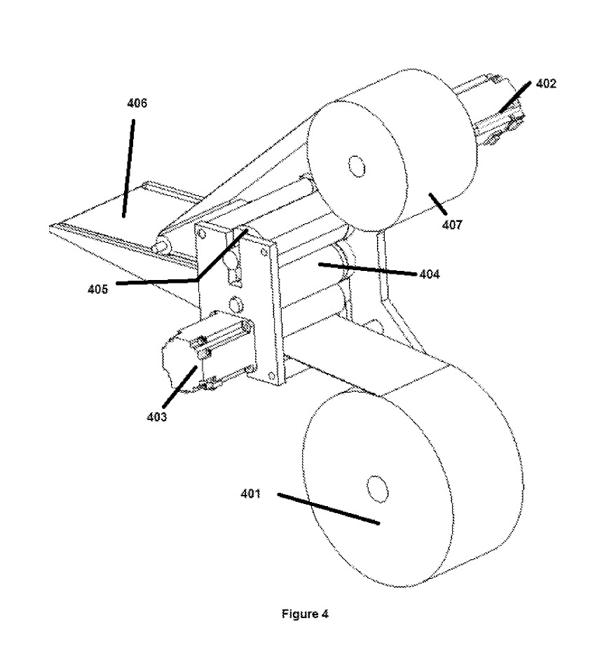

FIG. 4 is an illustration of another embodiment of the device that includes two motors for moving the linerless label through the unit.

### DETAILED DESCRIPTION OF THE INVENTION

The use of stickers or self-adhesive labels to identify an object with a word, graphic, or product name has been well-known to the labeling industry for a long time. Typically, stickers are made with an adhesive that is permanent, removable, or repositionable. For general use, the most common adhesive type is a permanent adhesive. It is typical in the prior art for a sticker to be made of three materials defined as the face material, the glue, and the back paper. The face material is where the matter is printed. The back paper is referred to as a liner, and it carries the face material prior to application of the label to an object. The liner has a release coat applied to it to prevent the labels from sticking on it. Glue may be applied to the liner and when joined with the labels, the glue is transferred to the labels allowing them to stick to other surfaces which do not have a release coat.

Label applicators in the prior art have traditionally used a liner as a carrier, which is then discarded during the rewinding process after the label is applied to an end user object. Linerless labels also exist in the prior art which use linerless label applicators having a temporary liner that can be reused or recycled, which creates excess waste. (See R. Phillips et al., Apparatus and Method for Applying Labels U.S. Pat. No. 7,556,708 (2009); G. A. Majkrzak et al., Apparatus and Method for Applying Linerless Labels U.S. Pat. No. 6,206,071 (2001), each of which is incorporated by reference in its entirety.) Linerless labels in the prior art also include the use of perforations to separate each label from the others. (See J. J. Boreali, et al., Detaching Linerless Labels U.S. Pat. No. 5,540,369 (1993), incorporated by reference in its entirety.)

Traditional linerless label devices operate by using non-stick methods such as vacuum technology to prevent the label from sticking to the equipment, or by using conveyor belts and rollers with a non-stick surface such as a plasma coating. (See J. J. Boreali, et al.; G. L. VanderSyde, et al., Linerless Label Application Assembly U.S. Pat. No. 7,121,311 (2003); T. E. Hansen, et al., Apparatus and Method for Applying Linerless Labels US 20030089452 (2003), each of which is incorporated by reference in its entirety.) These methods and devices allow the label to be linerless, however the prior art applicators still require use of a temporary liner, even then the linerless label module can be added to existing equipment that was designed for use with traditional lined labels. (See R. Phillips et al.; G. A. Majkrzak et al.; G. L. VanderSyde, et al. each of which is incorporated by reference in its entirety.) Vacuum technology to prevent the labels from sticking to the equipment often resulted in deformation of the labels. (See T. E. Hansen, et al.)

In the prior art, the labels were perforated as a part of their manufacturing process, so that they could be separated into individual pieces prior to their application. However this process is slower than that of die-cutting, and still requires use of a die to cut the linerless label before it is sent to the article to which it is to be applied. The perforated linerless labels are also limited in the shapes that can be produced for the label. A die cutter has also been used in the prior art, including the use of a cylindrical die, but not in combination with a belt to carry the label to the end user object. (See R. Phillips et al.; G. A. Majkrzak et al.) Prior application methods also include “bursting” the labels apart with a breaker blade. (See J. J. Boreali, et al.) The use of the prior art linerless labels and applicators has been limited due to difficulties in application of the labels to end use products.

The present invention overcomes the difficulties of the prior art, and will provide increased marketability of linerless label technology.

An apparatus for the application of linerless labels that eliminates the difficulties typically associated with the application of labels to end user products can be achieved by the application of a linerless label with a belt instead of a liner to carry the label to the end user product. An improved apparatus for a linerless label applicator can also be achieved by die cutting the labels at the site of application, when on the carrier belt, instead of using perforations, created off-site, as a joining element between the labels, so that the labels can be cut to the required shape and delivered directly to the package or item to be labeled.

The present invention provides a method to apply a linerless label to an end user product in a manner that is easy to use. This invention will be useful to the sticker, or label, industry and its use will save costs, reduce wasteful material, and reduce harmful effects to the environment. Without a liner, twice the amount of label can be wound into one roll, saving space and transportation costs. By die-cutting the labels, they can be applied at the site of product labeling without impacting the speed of the production line.

This method and apparatus configuration is used to apply a linerless label to an end user product by using a belt so that glue does not stick onto it, and the belt will also carry the face material instead of using a liner to carry the face material. This method and apparatus for applying a linerless label makes use of three machines: one machine at the printer location which prints and applies a release coat to the label, another machine at the printer location which applies the glue to the label, and one machine at the end user or customer location, which applies the label and is to be added as a module to the customer's existing label applicator machine. However, the steps may be taken by any number or combination of machines. The first machine (not shown) at the printer location includes a printer, a label, and a release coat applicator. The second machine (101) at the printer location includes a glue applicator (102), an unwinder unit (103), a rewinder unit (104), a slitting knife or knives (105), a nip roller (106), a chill roller (107), and a belt (108). The unwinder unit and rewinder unit are used to move the printed label (109) past the belt so that glue can be applied to the printed label.

The machine, or module (301), located at the end user's location includes an unwinder unit (302), a die cutting station (303), a belt (304), and a nip roller (305). The material of the belt is nonconsequential, what is important is that a coating to prevent sticking, such as a release coat, is applied to the belt. The release coat could be silicon coating, plasma, or any other known material of a non-adhesive nature.

In one embodiment, the linerless label is printed prior to its being used in the glue-application machine described above. The linerless label is made by having a printer print on the face of the label; having the face of the label coated with a release coat so that the glue will not later stick to the printed surface of the label; and then the label is wound. The label is then transferred to the glue-application machine.

The glue is applied with a glue application machine in the following manner. The printed label (109) is positioned on the unwinder unit (103), glue is applied to the belt (108) with the glue applicator (102), and then the unwinder unit unwinds the label and positions the back surface of the label on top of the belt. (FIG. 1.) The nip roller (106) applies a pressure to the printed face surface of the label which is now on top of the belt to cause the glue to transfer from the belt to the back surface of the label. The chill roller (107) cools the temperature of the glue. In the embodiment shown in FIG. 1, the chill roller and belt form an integrated unit, such that the belt wraps around the chill roller, in another embodiment a sleeve is wrapped around the chill roller and secured in place. Once the glue is transferred to the printed material, the slitting knives (105) slit the label into width sizes desired by the end user. Then the label is rewound into a roll with the rewinder unit (104), so that the label now resembles a roll of tape with adhesive on it.

In a further embodiment, the belt and chill roller or drying unit are in a non-integrated configuration. (FIG. 2.) In this embodiment, the release coating is applied to the label with the release coating applicator (201) and then it is passed through a drying oven (202) to cure or dry. The glue application process occurs when the glue is pushed from the hot melt tank (203) to the slot die (204). From there, the glue is applied through the slot die onto the belt (205) of the chill roller (206) or drying unit. The face material of the liner (207) and the belt (205) both pass through the nip roller (208) and support roller (209) for lamination.

The label is then taken to the site of the module, or second applicator described above, to be applied to the end user product. In the apparatus depicted in FIG. 3, the module is attached to an existing applicator unit. The label (306), once it has been printed and has had glue applied to it, is positioned on the unwinder (302). From there, the label (306) is unwound and positioned on the belt (304), with a nip roller (305) applying pressure against the label (306) and belt (304). The belt (304) carries the label (306) through the die cutter apparatus which cuts the label into the end user's desired shape. In one embodiment, the belt then continues to carry the label all the way through the existing applicator unit (307) until it is applied to the end user product. In one embodiment, the die cutter may be cylindrical. In another embodiment, the die cutter may be a laser die cutter. In a further embodiment, the die cutter may be a flat-bed die cutter. In a further embodiment, the die cutter may be a full rotary or semi-rotary die cutter.

An alternative to the three machine embodiment includes application of the release coat and glue at the printer location, and then the die cutting and application of the label at the customer location. Alternatively, all functions, including printing, can be performed at the customer location, so that printing is performed on a roll of labels that are inserted into one machine that applies the release coat, glue, die cutting, and application to the end user product.

FIG. 4 shows another embodiment of the invention. A roll of printed labels with release coat on the top side and glue on the bottom side already applied is placed on the unwinder unit (401). The machine includes two servo motors (402) and (403), which serve to pull the linerless label material from the unwinder unit (401). The linerless labels then pass through anvil cylinder (404) and magnetic cylinder (405) for die cutting. A die cutting sheet with the appropriate shape of labels is placed over the magnetic cylinder (405) to effect the die cutting. The linerless labels can optionally pass through a nip roller prior to the die cutting operation. A belt (406) rotates around the anvil cylinder (404). The belt (406) can be made of any suitable material, as long as it does not allow the bottom side of the linerless labels which have glue on them to stick to the belt. The belt can also be coated with any suitable material to prevent sticking of the linerless labels, such as a release coat. After the die cutting operation, the cut labels remain on the belt, while the waste material is pulled onto the rewinder (407). In one embodiment, the labels are then transported on the belt until they reach the edge of the machine where they are applied directly to the end user products.

In the embodiment of FIG. 4, a single machine can die cut the label and apply it directly to the end user products. The preferred embodiment of FIG. 4 is one that completely replaces an existing applicator, but in another embodiment it can be an add-on module to an existing applicator.

In one embodiment, the excess, or waste label, that is not applied to the end user product can be taken to a rewinder unit (404) of the applicator. In another embodiment, the waste material can be taken back to an unwinder unit within the module.

The method and apparatus described here will be useful to existing manufacturers of label applicator equipment and to specialist die cutting manufacturers, which could manufacture the apparatus. The apparatus described here can be used as an additional module to existing production lines. By overcoming existing difficulties in the field of linerless labels, the apparatus here will have improved marketing value. This apparatus will be more appealing to the label application industry because they will only have to purchase this apparatus instead of purchasing an entirely new system to apply labels. This apparatus is also appealing because by eliminating the need for a liner, those in the label application industry can purchase labels at a lower cost.

Other embodiments are within the scope of the following claims:

1. A system for preparing a linerless label for use in a linerless label applicator, comprising:
a first device with a printer for printing on a face surface of a linerless label, a linerless label having a face surface and a back surface, and a release coat applicator for applying a release coat to the face surface of the label; and
a second device comprising an unwinder unit to unwind a roll of printed linerless label;
a belt to assist application of glue to the linerless label;
a glue applicator positioned near the belt, wherein the glue applicator applies glue to the belt;
a nip roller positioned above the face surface of the linerless label so that when it contacts and applies pressure to the linerless label the glue on the belt transfers from the belt to the back surface of the linerless label;
at least one slitting knife to pre-cut the linerless label, positioned above the face surface of the linerless label and in between the belt and a rewinder unit; and
a rewinder unit to rewind the linerless label after it has been glued and pre-cut.

2. The system of claim 1 wherein the glue applicator is a component of the first device.

3. The system of claim 1 wherein the printing is done prior to application of glue to the label by the glue applicator.

4. The system of claim 1 further comprising a chill roller.

5. The system of claim 4 wherein the belt wraps around the chill roller.

6. A device for applying a linerless label to an end user object, comprising:
a roll of linerless label having a face surface and a back surface;
an unwinder unit on which the roll of linerless label can be positioned;
a belt positioned to move between the unwinder unit and an applicator unit;
a die cutting apparatus near the belt, capable of cutting the linerless label into an end user's desired shape;
a nip roller capable of applying pressure to a face surface of the linerless label; and
an applicator unit capable of receiving the belt and linerless label, and further capable of applying the linerless label to the end user object.

7. The device of claim 6 wherein the die cutting apparatus is a cylindrical die cutter.

8. The device of claim 6 wherein the die cutting apparatus is a laser die cutter.

9. The device of claim 6 wherein the die cutting apparatus is a flat-bed die cutter.

10. The device of claim 6 wherein the die cutting apparatus is a full rotary cutter.

11. The device of claim 6 wherein the die cutting apparatus is a semi-rotary cutter.

12. The device of claim 6 wherein the die cutting apparatus is a die cutting sheet.

13. The device of claim 6 wherein the device is a module capable of being attached to another applicator device.

14. A method of preparing a linerless label for use in a linerless label applicator, comprising the steps of:
printing on a face surface of a linerless label with a printer;
coating the face surface of the linerless label with a release coat;
winding the linerless label into a roll;
transferring the roll of linerless label to a second device where it is positioned on an unwinder unit;
unwinding the roll of linerless label and positioning it on top of a belt;
applying glue with a glue applicator to the belt; applying a pressure with a nip roller to the face surface of the linerless label so that the glue on the belt transfers from the belt to a back surface of the linerless label;
moving the linerless label forward and slitting it with at least one slitting knife;
and rewinding the linerless label with a rewinder unit.

15. The method of claim 14 wherein the label is printed prior to application of the glue.

16. The method of claim 14 wherein the glue is applied prior to slitting the label.

17. A method for applying a linerless label to an end user object, comprising the steps of:
positioning a roll of linerless label on to an unwinder unit;
unwinding the linerless label and positioning it on top of a belt, wherein the belt is positioned to move between the unwinder unit and an applicator unit;
applying pressure to a face surface of the linerless label with a nip roller, wherein the nip roller applies pressure against the face surface of the linerless label and the belt;
carrying the linerless label on the belt past a die cutting apparatus where the linerless label is cut into an end user's desired label shape;
carrying the linerless label on the belt to an applicator unit; and
applying the linerless label to an end user product.

18. The method of claim 17 wherein the die cutting apparatus is a cylindrical die cutter.

19. The method of claim 17 wherein the die cutting apparatus is a laser die cutter.

20. The method of claim 17 wherein the die cutting apparatus is a flat-bed die cutter.

21. The method of claim 17 wherein the die cutting apparatus is a full rotary cutter.

22. The method of claim 17 wherein the die cutting apparatus is a semi-rotary cutter.

23. The method of claim 17 wherein the die cutting apparatus is a die cutting sheet.

24.-34. (canceled)
